(19) United States
(12) Patent Application Publication
(10) Pub. No.: US 2021/0197268 A1
(43) Pub. Date: Jul. 1, 2021

(54) COPRINTED SUPPORTS WITH PRINTED PARTS

(71) Applicant: HEWLETT-PACKARD DEVELOPMENT COMPANY, L.P., Spring, TX (US)

(72) Inventors: Krzysztof Nauka, Palo Alto, CA (US); Thomas Anthony, Palo Alto, CA (US)

(21) Appl. No.: 16/606,299

(22) PCT Filed: Jun. 8, 2018
(86) PCT No.: PCT/US2018/036617

§ 371 Date: Oct. 18, 2019

(51) Int. Cl. B22F 10/10; B22F 10/20; B22F 10/40; B29C 64/40; B22F 3/10; B22F 12/00

(52) U.S. Cl. CPC B22F 10/10; B22F 10/20; B22F 10/40; B33Y 40/00; B22F 3/1021; B22F 12/00; B29C 64/40

(57) ABSTRACT

A system for forming a part with a support including: a liquid reservoir to hold a support material to form the support; an ejector to receive support material from the liquid reservoir and deposit the support material into a build area; an actuator to provide relative motion between the ejector and the build area; and a spreader to form a layer of metal particles in the build area, wherein the support provides support for the part during sintering.

### BACKGROUND

This disclosure relates to three dimensional printing of parts. Specifically, this disclosure relates to systems and methods to reduce distortion in a three dimensional printed part during a subsequent heating operation, such as debinding, sintering, and/or increasing density.

### BRIEF DESCRIPTION OF THE DRAWINGS

The accompanying drawings illustrate various examples of the principles described herein and are a part of the specification. The illustrated examples do not limit the scope of the claims.

FIG. 1 depicts a system for forming a part with a support according to an example consistent with the present specification.

FIGS. 2A-2D depict a series of points in forming a support for a part according to an example consistent with this specification.

FIGS. 3A-3D a series of points in forming a support for a part according to an example consistent with this specification.

FIG. 4 depicts a system for forming a part with a support according to an example consistent with the present specification.

FIG. 5 shows a flowchart for a method of forming a metal part according to an example consistent with the present specification.

Throughout the drawings, identical reference numbers designate similar, but not necessarily identical, elements. The figures are not necessarily to scale, and the size of some parts may be exaggerated and/or minimized to more clearly illustrate the example shown. The drawings provide examples and/or implementations consistent with the description. However, the description is not limited to the examples and/or implementations shown in the drawings.

### DETAILED DESCRIPTION

Forming three-dimensional printed parts from metal rather than polymer provides a number of benefits. Metals allow material properties not found in polymers and other types of materials. Metals may have break strength, ductility, conductivity, yield strengths, and other properties that are difficult to reproduce with polymers and ceramics. The rise of engineering polymers such as polyetheretherketone (PEEK) have increased the options for polymers but engineering polymers may have limited strength, ductility, and conductivity. Accordingly, metal parts will continue to be used in various applications for the foreseeable future.

Metal parts have generally been made with machining and/or casting. Swiss and computer numerical control (CNC) mills may be used to automate or semi-automate production of small metal parts. However, such systems tend to be operated on a setup-and-let-run model rather than an on-demand approach. In contrast, printing of parts has been seen as a method of providing parts on demand while allowing a high degree of customization of a given part. Printing parts also allows formation of geometries which may be difficult and/or impossible to form with other methods.

Three dimensional forming of metal parts may include applying a binder to metal particles to form a green part. The green part is then heated. During heating, the binder is removed, for example, by volatilization and/or combustion. The part is sintered together to form a solid object. In some examples, the part is further heated to densify the metal part.

When loosely packed, metal particles may have a density of less than 50% of their consolidated density. Vibration and mechanical packing may be used to increase the density of the particles prior to heating. However, even under optimal conditions, the metal particles will more resemble spheres than cubes. This results in interstitial space between particles that is occupied by air, reducing the density of the part.

In some 3-D metal part processes, post-forming heating includes a first temperature where a binding agent is removed, a higher second temperature where sintering occurs and a third even higher temperature where densification happens. However, there is a challenge in that once the binding agent is removed, the binding agent no longer provides support for the 3-D formed shape. As the part is heated to sintering temperature, the part may sag, deform, and/or collapse. Sagging, collapse and/or deformation may become even more severe during densification.

Densification also produces shrinkage, i.e., a reduction in dimensions for the part, as the empty areas between particles are filled by mobile metal atoms at elevated temperature. However, reduction in metal strength at temperatures needed for sintering may cause undesired deformation of the part, in addition to unavoidable shrinkage. Densification may include higher temperatures than sintering and may include liquefaction of some metal in the part.

As used in this specification and the associated claims, a “green part” is a part formed from particles which requires a thermal process before finalization. A green part may include a binder which is chemically and/or thermally removed (debind) as part of post forming processing. A green part may be subjected to a sintering and/or densification process as the secondary process. The term “green part” is used in the field of powder metallurgy.

As used in this specification and the associated claims, “debind” is the process of thermally and or/chemically removing a binding agent from a green part. Such binding agents are often organic and are either decomposed and/or combusted. Binding agents may hold the green part in its formed shape during forming and post-forming operations. For example, a binding agent may hold the green part together during removable of excess material in layers of the formed structure that will not become part of the green part.

As used in this specification and the associated claims, “sintering” is the process of bringing a material to a temperature sufficient to allow diffusion of the material into adjacent material without liquefaction. The adjacent material may be the same and/or different material. Sintering may include a debind operation, a consolidation operation, and/or a densification operation. In an example, an initial sintering is performed to increase the strength of the part, the support may then be removed and a secondary sintering performed to further consolidate the part.

This specification also describes a system for forming a part with a support including: a liquid reservoir to hold a support material to form the support; an ejector to receive support material from the liquid reservoir and deposit the support material into a build area; an actuator to provide relative motion between the ejector and the build area; and a spreader to form a layer of metal particles in the build area, wherein the support provides support for the part during sintering.

Among other examples, this specification also describes a system for forming a part with a support, the system including: a first liquid reservoir to hold a support material to form the support; a first ejector to deposit the support material into a build area; a second liquid reservoir to hold a binding agent; a second ejector to deposit the binding agent into the build area; an actuator to provide relative motion between the first ejector and the build area; and a spreader to form a layer of metal particles in the build area, wherein the support material comprises an oxide and the support provides support to the green part during sintering.

Among other examples, this specification also describes a method of forming a metal part, the method including: forming, by layers, a metal part and a support for the metal part; and sintering the metal part while the metal part is supported by the support.

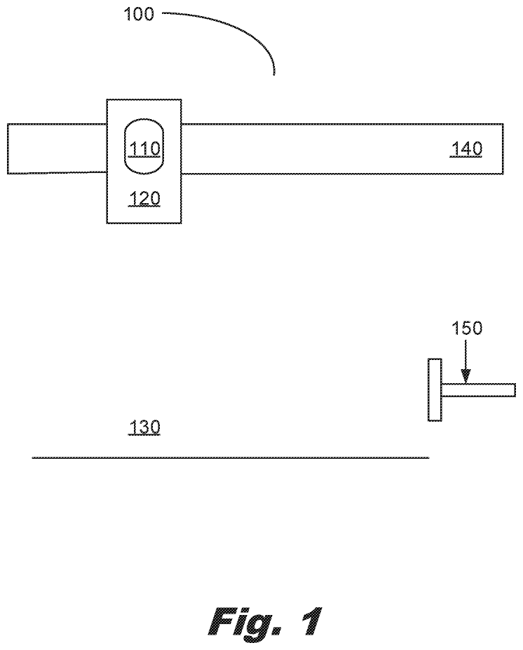

Turning now to the figures, FIG. 1 depicts a system (100) for forming a part with a support according to an example consistent with the present specification. The system (100) comprising: a liquid reservoir (110) to hold a support material to form the support; an ejector (120) to receive support material from the liquid reservoir (110) and deposit the support material into a build area (130); an actuator (140) to provide relative motion between the ejector (120) and the build area (130); and a spreader (150) to form a layer of metal particles in the build area, wherein the support provides support for the part during sintering.

The system (100) is a system (100) for forming a support and a part during the same layer-by-layer forming process. This is done by providing a support material in a liquid reservoir (110) where the support material may be applied to form a support structure in a build area (130).

The liquid reservoir (110) contains support material that will become the support structure. The liquid reservoir (110) provides liquid to the liquid ejector (120).

The support material forms the support in the build area (130). The support provides support to the part during a subsequent thermal operation. The thermal operation may be debind, sintering, densification, and/or another thermal operation on the part. The part may include a binder. The part may be substantially free of binder, for example, having less than 1%, 0.1%, 0.01%, and/or 0.005% by weight of binder.

The support material may be a material selected from a group consisting of: alumina, silica, silicates, zirconia, titania, MgO, and mixtures thereof. The support material may include a clay. The support material may include a metal oxide. The support material may include a transition metal oxide. The support material may include a semimetal oxide and/or a non-metal oxide. Oxides tend to be thermally stabile due to their low potential state. The support material may include a ceramic precursor. The support may lack crack propagation resistance and/or overall strength. Indeed, the lack of such characteristics may make removal of the support easier after the support is no longer needed. The support material may be designed to undergo a structural change during heating.

The support material may include a polymer. Polymers with high decomposition temperatures may be particularly useful in this regard. For example, silicones are available in shelf-stable formulations and have notable temperature resistance compared with carbon-based polymers. Silicones may also be formulated to produce a wide variety of stiffnesses from floppy low stiffness materials to highly-crosslinked, firm silicones. The availability of silicone precursors and well understood kinetics of crosslinking make these attractive options for a support material.

The support material may include an ultraviolet (UV) curable polymer such as: an epoxy acrylate, aliphatic urethane acrylate, aromatic urethane acrylate, polyester acrylate, and/or acrylic acrylate. The support material may include a photopolymerizable polymer. The support material may include a thermosetting polymer, for example to bolster the strength of a ceramic shell. Some suitable thermosetting polymers include: polyurethanes, diallyl-phthalates, cyanate esters, polycyanurates, and/or epoxy resins.

The support material may be a ceramic powder ink and may contain (UV) curable component. In an example the UV curable component is activated and hardened while printing each layer.

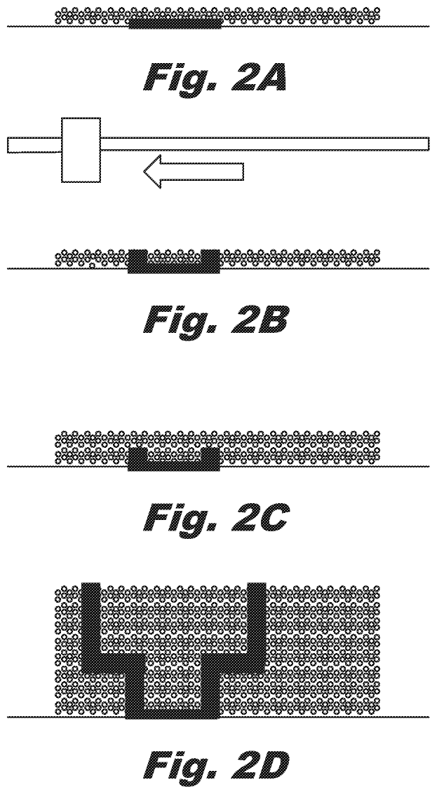

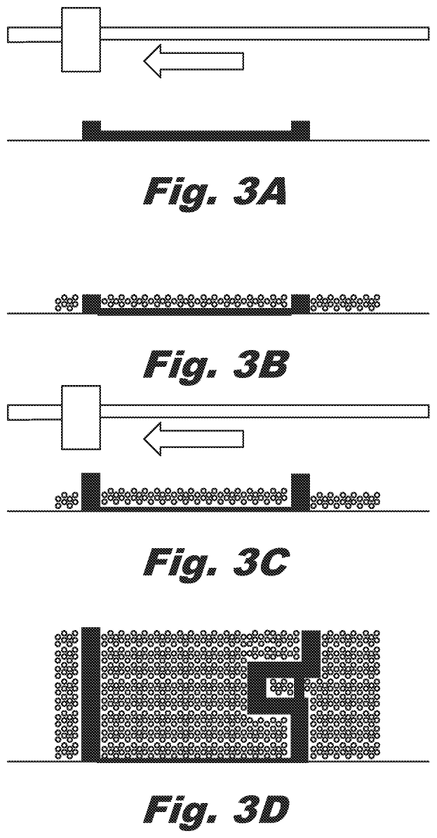

The support material may be applied to the layer of metal particles as shown in FIGS. 2A-D. The support material may be applied prior to forming the layer of metal particles as shown in FIGS. 3A-D.

The part may include a binder. The part may be formed without a binder. The part may have the binder removed during debind prior to sintering. The part may be subjected to an initial sintering, followed by removal of the support prior to a secondary sintering. The support may remain in place until the part has completed all its thermal operations.

The build area (130) is located in the path of the ejected material from the liquid ejector (120). The liquid ejector (120) may be located above the build area (130) to minimize the deflection from gravity. The liquid ejector (120) may be part of a printhead. In an example, the liquid ejector (120) and reservoir (110) are integrated into a single unit. The reservoir (110) may be replaceable. The reservoir (110) may include a port for refilling. The reservoir (110) may supply multiple liquid ejectors (120).

The actuator (140) provides relative motion between the liquid ejector (110) and the build area (130). In an example, the print area (130) is static and the actuator (140) moves the liquid ejector (120) in X and/or Y. The actuator may move the liquid ejector (120) in X, Y, Z, another axis, and/or combinations thereof. Full width liquid ejectors (110) provide an option to limit motion of the system. Actuator (140) systems may be used to move the build area (130) in X, Y, Z, and/or another axis. Both the liquid ejector (120) and the build area (130) may be moved simultaneously and/or separately to facilitate operations. All these combinations for relative motion between the liquid ejector (120) and the print area (130) are within the disclosed scope of this application.

The system (100) includes a spreader (150) to form layers of metal powder in the build area (130). A spreader (150) may include a blade. A spreader (150) may include a roller. A spreader (150) may deposit metal powder as part of forming the layer of metal powder. A spreader (150) may have another system provide the metal powder to the build area (130) while the spreader rearranges the supplied metal powder to form the layer. The spreader may remove excess amounts of metal powder when forming a layer of metal powder. The excess metal powder may be reused.

The spreader (150) may include a compactor to compact the powder layer. The spreader (150) may include a vibrator to compact the powder layer. The spreader (150) may be integrated with the liquid ejector (120) on a common carriage. The spreader (150) may move relative to the liquid ejector (120). Different designs have associated tradeoffs in terms of throughput, parts, reliability, cost, etc.

The spreader (150) may be used to form powder layers of a fixed thickness. The spreader (150) may form layers of different thickness through a build and/or between builds. Again, more flexibility tends to be associated with greater mechanical complexity which may be associated with greater costs and/or reduced mean time to failure for a device.

The system (100) may include a second reservoir (110) and a second liquid ejector (120). This second liquid ejector (120) may be used to dispense a binding agent on the layer of metal powder in the build area (130). The first and second reservoirs (110) and first and second liquid ejectors (120) may be integrated into a single printhead. The first and second liquid ejectors (120) may be in separate printheads and/or on separate carriages. The first and second liquid ejectors (120) may operate simultaneously and/or sequentially to apply the materials from the first and second reservoirs (110).

The support may include a shell. A shell is a support that enrobes and/or covers a majority of a surface of the green part. A shell may have openings, such as vents to allow escape of the binding agent during debind. The shell may be formed from a material which is brittle compared with the part such that the shell may be fractured to facilitate removal from the part. For example, the support may be a ceramic shell encompassing the part. The support may include a vent to allow outgassing during heating of a green part supported by the support.

The support may have a non-uniform thickness. A non-uniform thickness support may provide different levels of support to different portions of a part formed from the layer of metal particles. For example, the base of the support may be thicker than a top portion. Similarly, any non-uniformity may have the thickness and shape of the support designed to provide the desired support of the part, facilitate removal of the support after heating, and/or minimize deformation of the part during heating. The support may include a lower surface. In an example, a base for the support is produced using the same methods as forming the sides of the support. In an example, a base is prefabricated to speed production.

FIGS. 2A-2D depict structures at a series of points in forming a support for a green part according to an example consistent with this specification. FIG. 2A shows a layer of metal particles. The layer of metal particles may be formed in a variety of methods. In an example, a pusher (150) pushes metal particles across the deposition area forming the layer of metal particles. A system (100) may deposit an amount of metal particles into the deposition area and then use a blade to remove excess amounts and level the particles to form the layer of metal particles.

FIG. 2B shows the relative motion of a liquid ejector (120) and the layer of metal particles. The liquid ejector (120) contains material used to form the support. In this example, the material used to form the support is applied onto and around the metal particles. The material is applied to portions of the layer of metal particles to form the support. In an example, the support encompasses a portion of the metal part. The portion may be consolidated with a binder. The portion may be just the metal particles, without a binder. This choice may depend on the shape of the support being formed. In an example, the co-forming of a support with the part allows reduction and/or elimination of the binder while the support preserves the shape of the green part prior to sintering.

The support may include a lower surface and side walls. The support may include only sidewalls. The support may include a top surface. In some cases, it is advantageous to leave open the upper surface of the support. In contrast, providing support underneath the part is often useful as the part will tend to distort downward under gravity. Similarly, providing lateral support with a wall or walls may prevent the part from flowing outward or folding over during heating. The support may include a prefabricated base. The support may have a base which is fabricated as part of making the support.

FIG. 2C shows a second layer of metal particles formed on top of the first layer of metal particles. The second layer may be formed using the same approach as the first layer. The second layer may be formed with a different method. The thickness of the layers may be constant and/or vary. The thickness of the layer may depend on the desired resolution of the part. The thickness of the layer may depend on the penetrating ability of the binder and/or the material used to form the support. The penetration ability may depend on a temperature of the layer and/or deposition area. The deposition area (130) may be heated to increase the rate of reaction. The deposition area (130) may be heated from below so that the rate is kept lower until the layer is covered and then subsequently increases. This may increase the penetration of the binder and/or the support material.

FIG. 2D shows several layers of the part and associated support. The support and part are formed by layers. The liquid ejector (120) deposits support material forming the support. The support material in this example includes the metal particulate inside the support material. In some examples, the support material may include chemical bonds to the metal particles. For example, a silicone rubber matrix may include groups to react with metal oxides.

FIGS. 3A-3D depict structures at a series of points in forming a support for a green part according to an example consistent with this specification. In FIG. 3A, a liquid ejector (120) moves relative to a build area (130) and deposits material to form the support. This may be performed in a single pass and/or in multiple passes of the liquid ejector (120). The width of the support (direction extending from the part) may be varied depending on a local resolution of the part. There may be a tradeoff between cure time of the material forming the support and the thickness of the layer of the support. In FIG. 3A a base for the support has been created and sides of the support have started prior to providing the first layer of metal powder.

In FIG. 3B, a layer of metal powder is applied to the build area (130). The layer of the metal powder correlates with a thickness of the support material built-up and/or applied during FIG. 3A. In an example, the layer of metal powder is applied as a surplus of metal powder. The excess metal powder is then cleared with a blade/pusher to form the layer. Other approaches may also be used. It is desirable to get good coverage and uniform density in the metal powder layer. Some methods may have difficulty getting powder into the area behind a portion of the support; this may depend, in part on the speed forming the layer of the metal powder.

In an example, the blade forming the layer of metal powder and the liquid ejector (120) for depositing the support material are on a common carriage. The blade may precede the liquid ejector (120), leveling the layer ahead of deposition of the next layer of the support material. The use of a common carriage for both may reduce the number of parts in the system (100). The use of a common carriage may reduce the time per layer as both leveling and deposition occur simultaneously. Multiple carriages may be coordinated to function simultaneously on different portions of the build area (130). This provides additional order of operation and speed flexibility in exchange for more parts in the system (100).

FIG. 3C shows the build area (130) after another pass of the liquid ejector (120) to apply a next layer of the support material. In this example, the first two layers are purely vertical; however, other shapes can be readily created. The metal powder layer may be used as a base for the support material to build overhangs, buttresses, and other complex shapes of the support.

FIG. 3D shows a part and support after several layers have been built up in the build area (130). The processes for forming the part in FIGS. 2D and 3D are similar but differ in whether the support is applied prior to and/or after formation of the layer of metal powder. The other difference is that the support of FIG. 3D does not incorporate metal powder of the layer into the support. In contrast, the support of FIG. 2D may incorporate the metal powder into the support. Because the support in FIG. 3D is freestanding prior to provision of the metal powder layer, it may be useful to use materials that cure more rapidly. In an example, the system includes a heater, an ultraviolet (UV) source, an infrared (IR) light source, and/or other element to increase the cure speed of the support material.

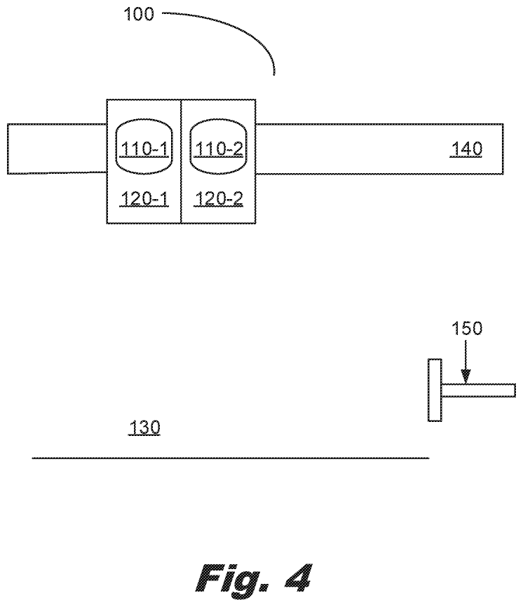

FIG. 4 depicts a system (100) for forming a part with a support according to an example consistent with the present specification. The system (100) includes: a first liquid reservoir (110-1) to hold a support material to form the support; a first ejector (120-1) to deposit the support material into a build area; a second liquid reservoir (110-2) to hold a binding agent; a second ejector (120-2) to deposit the binding agent into the build area (130); an actuator (140) to provide relative motion between the first ejector (120-1) and the build area (130); and a spreader (150) to form a layer of metal particles in the build area (130), wherein the support material comprises an oxide and the support provides support to the part during sintering.

As discussed with respect to FIG. 1, multiple reservoirs (110) and multiple ejectors (120) may be organized on a common carriage and/or on different carriages. The first reservoir (110-1) and second reservoir (110-1) may be arranged to move relative to each other. The first liquid ejector (120-1) and the second liquid ejector (120-2) may be arranged to use different actuators (140) to allow relative motion.

Forming the support from an oxide allow the use of materials with high temperature tolerances. In an example, the working temperature of the support material is above the melting temperature of the metal powder used to form the part. For example, silica may remain functional at temperatures up to approximately 1600° C. which is above the melting point of iron. Zirconia (zirconium dioxide) has a melting point of approximately 2,715° C. which is well above the melting temperature of many metals. Accordingly the selection of a proper oxide to form the support allows the support to function at sintering and densification temperatures. Silicone rubbers and organic polymers may be stable to about 800° C. before decomposing. This may be sufficient for the initial debind and/or sintering depending on the composition of the part.

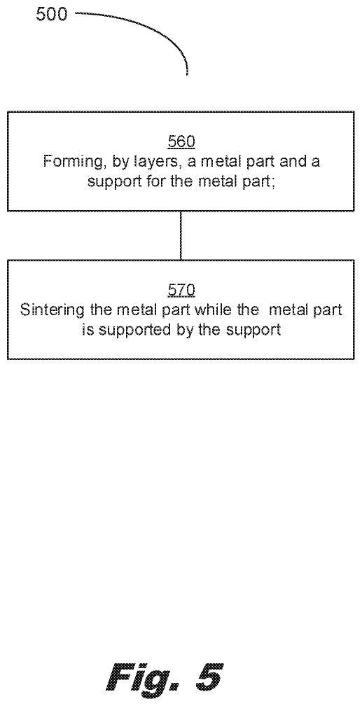

FIG. 5 shows a flowchart for a method (500) of forming a metal part according to an example consistent with the present specification. The method (500) includes: forming, by layers, a metal part and a support for the metal part (560); and sintering the metal part while the metal part is supported by the support (570).

The method is a method of forming a metal part. The method (500) includes forming a part and an associated support together layer by layer. The support then provides support to the part during sintering. The part may be a green metal part. The support may provide support during debind.

The method (500) includes forming, by layers, a metal part and a support for the metal part (560). By forming the support and the metal part together, the support can be produced in contact with the metal part and provide variable amounts of support to different portions of the metal part. If the support material and binder are provided by fluid ejectors (120) mounted on a common carriage, the additional time to form the support may be minimized. The support can be made using a variety of different materials however; metal, semimetal, and/or nonmetal oxides such as silica, silicates, alumina, titania, zirconia, etc. provide high temperature tolerances. Similarly, ceramic materials have a long history in high temperature use.

The use of polymers provides supports that are useful for lower melting point metals. Polymers have commercially-available, shelf-stable formulations. However, polymers also have less tolerance of higher temperatures.

The method (500) includes sintering the metal part while the metal part is supported by the support (570). As discussed previously, the support stabilizes the metal part to reduce sagging, bending, etc. Deformation of the part may occur during sintering. Deformation of the part may occur during densification. Deformation of the part may occur during debind. Accordingly, the use of a temperature resistant support facilitates stabilization of the part and reduces the stresses that might produce deformation.

The method may further include heating a green part, while the part is supported by the support, during debind. The support may include vents and/or openings to allow gas formed from the binder to escape. The method (500) may further include heating the part to sintering temperature. The method (500) may further include heating the part to densify the part. The method (500) may further include removing the support from the metal part after heating. In an example, the support is fractured and removed from the part as pieces.

The method (500) may further include removing the support from the sintered metal part prior to a second sintering operation. For example, additional densification may be performed after removal of the support.

The support is distinguished from the metal part itself by being formed of a different material and removed after the usefulness of the support in providing support is complete. The support may be removed to prevent the support for interfering with the expected use of the metal part. The support may be recyclable. The support may be disposable. Depending on the adhesion between the support and the part, additional finish methods may be used to separate the part from the support. For example, mechanical vibration, sandblasting, shot peening, chemical etching, and/or similar methods may be used. Selecting an appropriate support removal will depend on the material of the support, the adhesion between the support and the part, and the desired finish of the part itself. In some examples, removing the support may be accomplished as part of other surface finishing operations so as to not increase the time and/or number of processes used to finish the metal part.

It will be appreciated that, within the principles described by this specification, a vast number of variations exist. It should also be appreciated that the examples described are only examples, and are not intended to limit the scope, applicability, or construction of the claims in any way.

What is claimed is:

1. A system for forming a part with a support comprising:
a liquid reservoir to hold a support material to form the support;
an ejector to receive support material from the liquid reservoir and deposit the support material into a build area;
an actuator to provide relative motion between the ejector and the build area; and
a spreader to form a layer of metal particles in the build area,
wherein the support provides support for the part during sintering

2. The system of claim 1, wherein the support material comprises a material selected from a group consisting of: alumina, silica, silicates, zirconia, titania, MgO, and mixtures thereof.

3. The system of claim 1, wherein the support material is applied prior to forming the layer of metal particles.

4. The system of claim 1, wherein the support material is applied to the layer of metal particles.

5. The system of claim 1, wherein the support material comprises a polymer.

6. The system of claim 1, further comprising a second ejector to provide a binding agent to a portion of the layer of metal particles, the portion forming a section of the part supported by the support.

7. The system of claim 1, wherein the support comprises a shell.

8. The system of claim 1, wherein the support comprises a vent to allow outgassing during heating of the part and the support.

9. The system of claim 1, wherein the support has a non-uniform thickness to provide variable levels of support to different portions of a part formed from the layer of metal particles.

10. System for forming a part with a support, the system comprising:
a first liquid reservoir to hold a support material to form the support;
a first ejector to deposit the support material into a build area;
a second liquid reservoir to hold a binding agent;
a second ejector to deposit the binding agent into the build area;
an actuator to provide relative motion between the first ejector and the build area; and
a spreader to form a layer of metal particles in the build area,
wherein the support material comprises an oxide and the support provides support to the part during sintering.

11. The system of claim 10, wherein the oxide is selected from a group consisting of: alumina, silica, silicates, zirconia, titania, and mixtures thereof.

12. The system of claim 10, wherein the support has a decomposition temperature greater than a melting temperature of a metal forming the part.

13. The system of claim 10, wherein the support material provides support for the part during debind.

14. A method of forming a metal part, the method comprising:
forming, by layers, a metal part and a support for the metal part; and
sintering the metal part while the metal part is supported by the support.

15. The method of claim 14, further comprising removing the support from the sintered metal part prior to a second sintering operation.
